(19) United States
(12) Patent Application Publication
(10) Pub. No.: US 2008/0224819 A1
(43) Pub. Date: Sep. 18, 2008

(54) MULTIPLE BARRIER OPERATOR SYSTEM

(75) Inventor: Donald Richard Callentine, Plainfield, IL (US)

Correspondence Address: FITCH EVEN TABIN AND FLANNERY, 120 SOUTH LA SALLE STREET, SUITE 1600, CHICAGO, IL, 60603-3406, US

(73) Assignee: THE CHAMBERLAIN GROUP, INC., Elmhurst, IL (US)

(21) Appl. No.: 11/687,471

(22) Filed: Mar. 16, 2007

(51) Int. Cl. H04Q 1/00

(52) U.S. Cl. 340/2.1

(57) ABSTRACT

A command is received at a controller of the barrier movement operator system and it is determined whether the command is a valid command. When the command is a valid command, at least one of the plurality of barriers to be controlled is identified based upon information included within the command. A motor is selectively coupled to the identified barrier or barriers and the motor is energized to move the one or more barriers.

### FIELD OF THE INVENTION

The field of the invention relates to moveable barrier operator systems and, more specifically, to operator systems having a plurality of barriers.

### BACKGROUND

Different types of moveable barrier operators have been sold over the years and these barrier operator systems have been used to actuate various types of moveable barriers. For example, garage door operators have been used to move garage doors and gate operators have been used to open and close gates.

Such barrier movement operators may include various mechanisms to open and close the barrier. For instance, a wall control unit may be coupled to the barrier movement operator and sends signals to a head unit thereby causing the head unit to open and close the barrier. In addition, operators often include a receiver unit at the head unit to receive wireless transmissions from a hand-held code transmitter or from a keypad transmitter, which may be affixed to the outside of the area closed by the barrier or other structure.

Multiple barriers are used in many circumstances. For example, many home owners utilize multiple garage doors at their homes. In another example, various types of businesses (e.g., trucking companies, warehouses) or government agencies (e.g., police and fire departments) employ multiple garage doors in their operations.

In previous systems, multiple operators were required to operate the multiple barriers. Specifically, a separate operator was used to move each of the barriers. While facilitating the use of multiple barriers, the use of multiple operators also created problems. For example, multiple operators were expensive to purchase and time-consuming to install. In addition, the multiple barrier operators had to be configured individually in order to operate properly leading to delays during the set up of the system. The maintenance of multiple barrier operators also was sometimes difficult and costly to perform due to the complexity of operating multiple operators.

### SUMMARY

Approaches are provided whereby multiple barriers are actuated by a single barrier operator. The use of a single device to control multiple barriers allows the cost and complexity of these systems to be significantly reduced. In addition, the amount of time required to setup and install the operators is reduced. Furthermore, performing maintenance functions in the system is greatly simplified and upgrades of the system are easier to perform resulting in significant costs savings as compared to previous systems.

As disclosed herein, a command is received at a controller in a barrier movement operator system and it is determined whether the command is a valid command. When the command is determined to be a valid command, at least one of the plurality of barriers to be controlled is identified based upon information included within the command. A motor is selectively coupled to the identified barrier or barriers and the motor is energized to move the one or more barriers.

A valid command may be determined based upon a variety of different tests or circumstances. For example, a valid command may be determined upon detecting matching codes or a valid command may be determined based upon the activation of a switch for a predetermined amount of time. Other examples of tests or circumstances may also be used to determine that a command is valid.

The coupling between the movable barrier operator and the barrier may also assume a number of different forms. For instance, a single clutch mechanism may be used to simultaneously control all of the plurality of barriers. In another example, a plurality of independent clutch mechanisms may be used to control each of the plurality of barriers independently from the others. In another example, a plurality of independent clutch mechanisms may be actuated to simultaneously control each of the plurality of barriers. In still another example, a plurality of independent clutch mechanisms may be actuated to simultaneously control at least one of the plurality of barriers.

Advantageously, obstruction detection approaches may be used in the multiple barrier systems described herein. In one example, an obstruction may be detected at one or more of the barriers, and a command may be transmitted to the barrier or barriers where the obstruction has been detected to take an evasive action. The evasive action may include opening a barrier, closing a barrier, or stopping the movement of a barrier. Other examples of evasive actions may also be taken.

The command received at the barrier operator that requests that one or more barriers be actuated may also take a number of forms. For example, the command may indicate the identity of a single barrier. In another example, the command may indicate the identities of a multiple barriers. The command may identify an action (e.g., open, close, halt movement) or may identify no action to take. In another example, the command may include information indicating an opening time or a closing time for the barrier.

The command may also assume a number of physical forms or formats. For example, the command may be transmitted from an RF transmitter and be in the form of an RF signal. In another example, the command may be transmitted from a keypad and be in the form of an electrical signal.

The system may also operate according to a variety of different operating modes. For example, each of the multiple of barriers may operate in a learn mode.

Thus, approaches are provided whereby multiple barriers are operated using a single barrier operator. The approaches are relatively easy to use and result in a user being able to control multiple barriers according to the users desires and using only a single barrier operator. System costs and complexity are reduced and the ability to maintain and/or upgrade the system are also enhanced.

### BRIEF DESCRIPTION OF THE DRAWINGS

FIG. 1 is a flowchart showing one approach for operating multiple barriers according to the present invention;

FIG. 2 is a diagram of a system for operating multiple barriers according to the present invention;

FIG. 3 is a diagram of another system for operating multiple barriers according to the present invention; and

FIG. 4 is block diagram of a moveable barrier operator used to move multiple barriers according to the present invention.

Skilled artisans will appreciate that elements in the figures are illustrated for ease of understanding and have not necessarily been drawn to scale. For example, the dimensions of some of the elements in the figures may be exaggerated relative to other elements to help to improve understanding of various embodiments of the present invention. Also, common but well-understood elements that are useful in a commercially feasible embodiment are often not depicted in order to facilitate a less obstructed view of the various embodiments of the present invention.

### DESCRIPTION

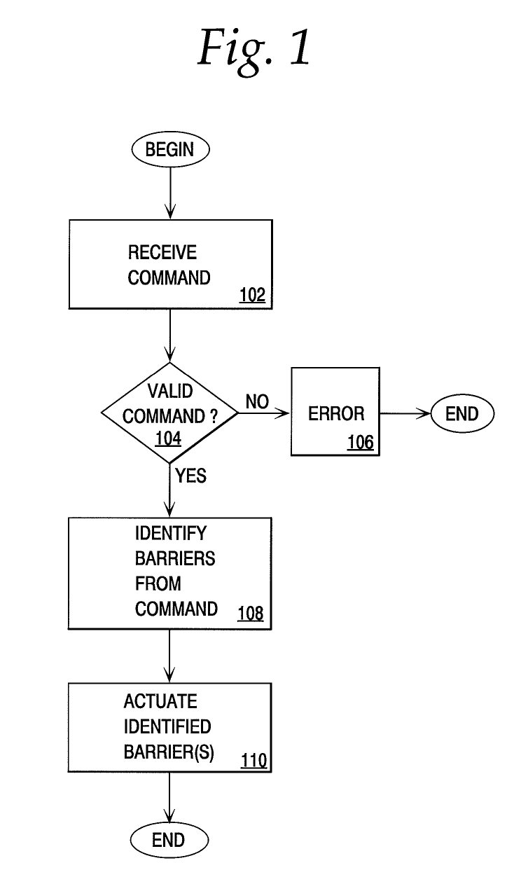

Referring now to the drawings and especially to FIG. 1, one example of an approach for operating multiple barriers is described. At step 102, a command is received at the barrier operator.

The command received at the barrier operator may assume a number of physical forms or formats. For example, the command may be transmitted from an RF transmitter and be in the form of an RF signal. In another example, the command may be transmitted from a keypad and be in the form of an electrical signal (e.g., having a predetermined voltage or current).

Regardless of its form or format, the command may include different types of information. For example, the command may include information identifying a single barrier or multiple barriers. Moreover, the command may identify a barrier actuation (e.g., open, close, halt movement) or, alternatively, the command may not identify an actuation. In another example, the command may include information indicating an opening time or a closing time for the barrier. The command may include a fixed code or the command may include a rolling code. If multiple barriers are identified, the command may identify an actuation sequence (i.e., the order of actuation of the barriers) or may indicate that the barriers are to be actuated simultaneously. Alternatively, a sequence of actuations of multiple barriers may not be identified in the command.

At step 104, the system determines if the command is a valid command. For example, the system may determine if the fixed or rolling code is valid or if a command actuation identified in the command is a valid actuation. If the answer is negative at step 106, then execution continues at step 106 where an error condition is identified and/or reported to a user. For example, the error condition may indicate that an invalid command has been received and indicate why the command is invalid.

If the answer at step 104 is affirmative, then at step 108, the barriers to be actuated are identified in the command. The barriers may be identified by a number or code, in some examples. In other examples, where the command is an electrical signal, the barriers may be identified by the identity of the input from which the signal originates, the voltage, current, or duration of the electrical signal. In other approaches where multiple keypads are used, specific keypads may be coupled to and used to actuate certain barriers. Other examples of approaches to identify the barrier or barriers in the received command are possible.

At step 110, the identified barrier or barriers is actuated. If a particular type of actuation (e.g., open, close, halt movement) is identified in the command, the barriers are actuated according to the actuation. If a particular barrier actuation sequence is identified in the command, then the barriers are actuated according to the sequence. Execution then ends.

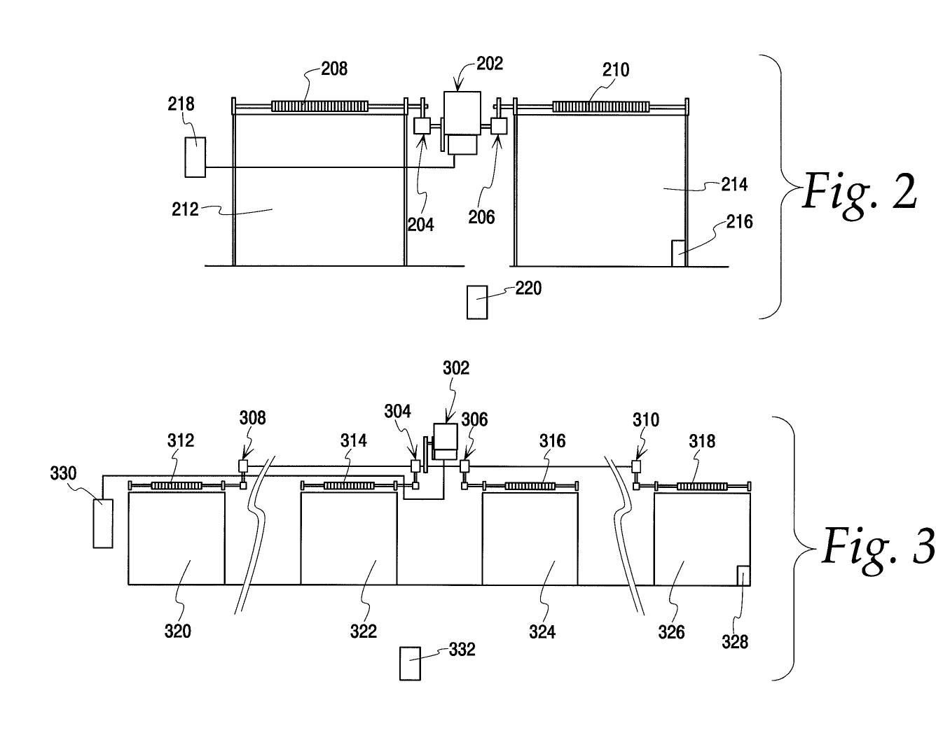

Referring now to FIG. 2, one example of a system for operating multiple barriers is described. A moveable barrier operator 202 is coupled to a first coupling mechanism 204 and a second coupling mechanism 206. The first coupling mechanism 204 drives a first jack shaft 208, which in turn moves a first barrier 212. The second coupling mechanism 206 drives a second jack shaft 210, which in turn moves a second barrier 214. The second barrier 214 has an associated obstruction detection device 216. In this example, the barrier operator 202 is centrally located between the first barrier 212 and the second barrier 214. Alternatively, the barrier operator 202 may be positioned at the end of a shaft that is coupled to each of the barriers 212 and 214. A keypad 218 is coupled to the operator 202 and is used to enter commands to actuate one or more of the barriers. Similarly, a portable transmitter 220 can transmit radio frequency (RF) signals that can be used by the operator 202 to actuate one or more of the barriers. Other keypads may also be used and in some approaches specific keypads may be used or assigned to actuate specific barriers.

The moveable barrier operator 202 may be any type of operator such as a garage door operator or a gate operator. The moveable barrier operator 202 includes one or more motors that move the barriers.

The coupling mechanisms 204 and 206 couple a motor (or motors) in the moveable barrier operator 202 to the jack shafts 208 and 210. In one example, the coupling mechanisms 204 and 206 may be clutch mechanisms. In this regard, the coupling mechanisms 204 and 206 may include switches, pulleys, gears, levers, springs, wires, or any other type of mechanical component that couple the motor of the operator to the jack shaft (which drives the barrier). The coupling mechanisms 204 and 206 may be used to simultaneously control all of the plurality of barriers. In another example, the coupling mechanisms 204 and 206 may control each of the barriers 212 and 214 independently from the others. In yet another example, the coupling mechanisms 204 and 206 may be actuated to simultaneously control each of the barriers 212 and 214. In still another example, the coupling mechanisms 204 and 206 may be actuated to control only one of the barriers 204 or 206.

The barriers 212 and 214 may be any type of barrier such as garage doors, swinging gates, sliding gates, or shutters. The barriers 212 and 214 may be different types of barriers, while, in other examples, may both be the same type of barrier.

The obstruction detection device 216 may be any type of device or combination of devices that is used to detect an obstruction in the pathway of the barrier. Although only one obstruction detection device 216 is shown in FIG. 2, it will be appreciated that more than one (or all) the barriers may include the use of an obstruction detection device.

When an obstruction is detected, and the barrier operator 202 may operate the barriers 212 or 214 to take an evasive action. The evasive action may include opening a barrier, closing a barrier, or stopping a movement of the barrier.

In one example of the operation of the system of FIG. 2, a command is transmitted or entered at either the keypad 218 or transmitter 220 and received at the barrier movement operator 202. The operator 202 determines whether the command is a valid command. When the command is a valid command, one or more of the barriers 212 or 214 to be controlled is identified based upon information included within the command. A motor (within the operator 202) is selectively coupled to the identified barrier or barriers and the motor is energized to move the one or more barriers 212 and/or 214.

A valid command may be determined based upon a variety of different circumstances. For example, a valid command may be determined when a matching code is detected or the valid command may be determined upon the activation of a switch for a predetermined amount of time.

The command received at the barrier may include different types of information in a variety of different formats. For example, the command may indicate the identity of a single barrier. In another example, the command may indicate the identities of a multiple barriers.

The system may also operate according to a variety of different operating modes. For example, each of the barriers may operate in a learn mode. Other types of operating modes may also be used.

Referring now to FIG. 3, another example of a system for actuating multiple barriers is described. A moveable barrier operator 302 is coupled to a first coupling mechanism 304, a second coupling mechanism 306, a third coupling mechanism 308, and a fourth coupling mechanism 310. The first coupling mechanism 304 drives a first jack shaft 314, which in turn moves a first barrier 322. The second coupling mechanism 306 drives a second jack shaft 316, which in turn moves a second barrier 324. The third coupling mechanism 308 drives a third jack shaft 312, which in turn moves a third barrier 320. The fourth coupling mechanism 310 drives a fourth jack shaft 318, which in turn moves a fourth barrier 326. The fourth barrier 326 has an associated obstruction detection device 328.

The barrier operator 302 is shown positioned in the middle of the barriers 320, 322, 324, and 326. Alternatively, the barrier operator 302 may be positioned at the end of a shaft that is coupled to each of the barriers 320, 322, 324, and 326. A keypad 330 is coupled to the operator 302 and is used to enter commands to actuate barriers. Similarly, a portable transmitter 332 can transmit radio frequency (RF) signals that can be used by the operator 302 to actuate barriers. In other approaches additional keypads may be used and each of the keypads may be used to actuate specific barriers. For instance, one keypad may be used to actuate the barriers 320 and 322 while another keypad may be used to actuate the barriers 324 and 326. In still another example, the keypad 330 may actuate some of the barriers while transmitter 332 may actuate the others.

The moveable barrier operator 302 may be any type of operator such as a garage door operator or a gate operator. The moveable barrier operator 302 includes one or more motors.

The coupling mechanisms 304, 306, 308, and 310 couple a motor (or motors) in the moveable barrier operator 302 to the jack shafts 312, 314, 316, and 318. In one example, the coupling mechanisms 304, 306, 308, and 310 may be clutch mechanisms. In this regard, the coupling mechanisms 304, 306, 308, and 310 may include switches, pulleys, gears, levers, springs, wires, or any other type of mechanical component that couple the motor of the operator to the jack shaft (which drives the barrier). The coupling mechanisms 304, 306, 308, and 310 may be used to simultaneously control all of the plurality of barriers. In another example, the coupling mechanisms 304, 306, 308, and 310 may control each of the barriers 320, 322, 324, or 326 independently from the others. In yet another example, the coupling mechanisms 304, 306, 308, and 310 may be actuated to simultaneously control each of the barriers 320, 322, 324, or 326. In still another example, the coupling mechanisms 304, 306, 308, and 310 may be actuated to control only one, two, or three of the barriers 304, 306, 308, and 310.

The barriers 320, 322, 324, or 326 may be any type of barrier such as garage doors, swinging gates or sliding gates. The barriers 320, 322, 324, or 326 may each be a different type of barrier, may all be the same type of barrier, or may be a mixture of different types of barriers.

The obstruction detection device 328 may be any type of device that is used to detect an obstruction in the pathway of the barrier. Although only one obstruction detection device 328 is shown in FIG. 3, it will be appreciated that more than one (or all) the barriers may include the use of an obstruction detection device.

When an obstruction is detected, and the barrier operator 302 may operate the barriers 320, 322, 324, or 326 to take an evasive action. The evasive action may include opening a barrier, closing a barrier, or stopping a movement of the barrier.

In one example of the operation of the system of FIG. 3, a command is transmitted or entered at either the keypad 330 or transmitter 332 and received at the barrier movement operator 302. The operator 302 determines whether the command is a valid command. When the command is determined to be a valid command, one or more of the barriers 320, 322, 324, or 326 to be controlled is identified based upon information included within the command. A motor (within the operator 302) is selectively coupled to the identified barrier or barriers and the motor is energized to move the one or more barriers 320, 322, 324, and/or 326.

As with the system of FIG. 2, a valid command may be determined using a number of different approaches. For example, a valid command may be determined when matching codes exist or the command may be determined to be valid upon the activation of a switch for a predetermined amount of time.

Also as with the system of FIG. 2, the command received at the barrier may take a number of forms and include different types of information. For example, the command may indicate the identity of a single barrier. In another example, the command may indicate the identities of a multiple barriers. Other types of information may also be included in the command.

Similarly, the system may operate according to a variety of different operating modes. For example, each of the barriers 320, 322, 324, and 326 may operate in a learn mode. Other examples of modes may also be used.

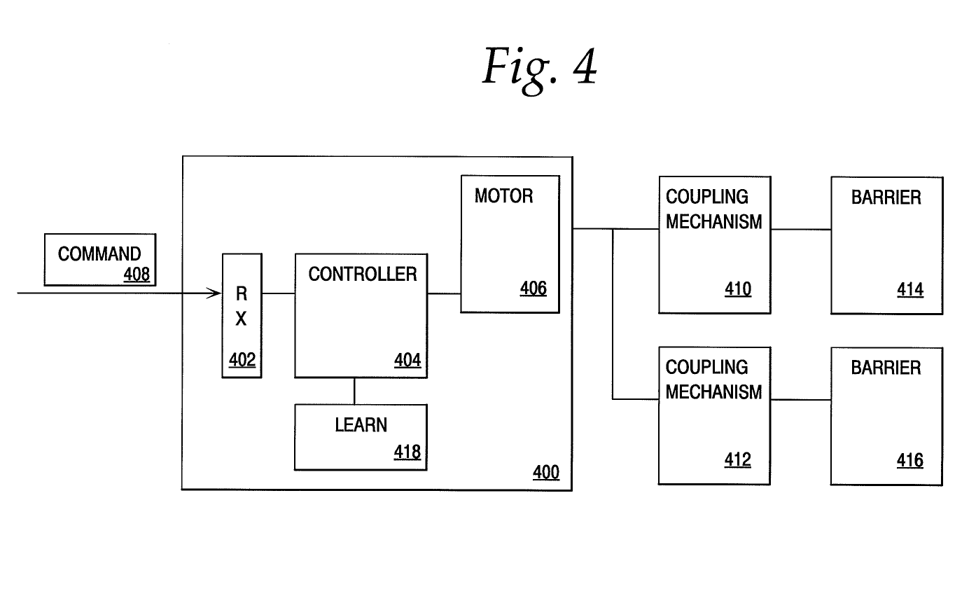

Referring now to FIG. 4, one example of a device 400 (e.g., barrier operator or barrier operator power plant) for operating multiple barriers is described. The device 400 includes a receiver 402, a controller 404, a motor 406, and a learn actuator 418. The motor 406 is used to drive coupling mechanisms 410 and 412, which in turn move barriers 414 and 416.

The receiver 402 may be configured to receive commands a wide variety of signals of different formats. For example, the receiver 402 may be an RF receiver that receives RF signals from a portable transmitter. In another example, the receiver 402 may be an interface that receives electrical signals from one or more keypads. In still another example, the receiver 402 receives multiple types of signals (e.g., both RF and electrical signals).

Commands 408 are received at the receiver 402. The commands 408 may originate from a user operating a transmitter and/or a keypad and may arrive via any interface (e.g., an RF interface or over wired connections) or may arrive via a combination of interfaces. The commands 408 may indicate the identity of a single barrier or the identities of a multiple barriers. In addition, the commands 408 may identify an action (e.g., open, close, halt movement) or may not indicate an action.

The controller 404 is programmed to determine whether the commands 408 are valid commands. When the commands 408 are valid commands, the controller 404 determines an identity of one or both of the barriers 414 or 416 based upon information included within the commands 408. Upon determination of the identity of the barrier(s), the controller 404 couples the motor 406 to one or both of the coupling mechanisms 410 or 412 in order to actuate one or both of the barriers 414 or 416.

The learn actuator 418 may be a button or switch at the operator 400. When the learn actuator 418 is actuated (e.g., pressed), the operator 400 enters a learn mode where commands or codes received at the receiver 402 are learned by the operator 400. Optionally, the operator 400 may also be coupled to one or more obstruction detection devices that have been described elsewhere in this disclosure.

Thus, approaches are provided whereby multiple barriers are operated using a single barrier operator. The approaches are relatively easy to use and result in a user being able to control multiple doors according to the users desires and using only a single barrier operator. System costs and complexity are reduced and the ability to maintain and/or upgrade the system are enhanced.

While there has been illustrated and described particular embodiments of the present invention, it will be appreciated that numerous changes and modifications will occur to those skilled in the art, and it is intended in the appended claims to cover all those changes and modifications which fall within the true scope of the present invention.

What is claimed is:

1. A method for controlling a plurality of barriers in a motor-driven barrier movement operator system comprising:
receiving a command at a controller of the barrier movement operator system;
determining whether the command is a valid command;
when the command is a valid command, identifying at least one of the plurality of barriers to be controlled based upon information included within the command;
selectively coupling a motor to the identified at least one of the plurality of barriers; and
energizing the motor.

2. The method of claim 1 wherein the command comprises an RF signal transmitted by a portable transmitter.

3. The method of claim 1 wherein the command comprises an electrical signal from a keypad.

4. The method of claim 1 wherein the valid command is selected from a group comprising a matching code and a command switch activation for a predetermined amount of time.

5. The method of claim 1 wherein selectively coupling comprises actuating a single clutch mechanism to simultaneously control all of the plurality of barriers.

6. The method of claim 1 wherein selectively coupling comprises actuating a plurality of independent clutch mechanisms to control each of the plurality of barriers independently from the others.

7. The method of claim 1 wherein selectively coupling comprises actuating a plurality of independent clutch mechanisms to simultaneously control each of the plurality of barriers.

8. The method of claim 1 wherein selectively coupling comprises actuating a plurality of independent clutch mechanisms to simultaneously control at least one of the plurality of barriers.

9. The method of claim 1 comprising detecting an obstruction at a selected one of the plurality of barriers.

10. The method of claim 9 comprising upon detecting the obstruction, transmitting a command to the selected one of the plurality of barriers to take an evasive action.

11. The method of claim 10 wherein the evasive action is selected from a group comprising: opening a barrier, closing a barrier, and stopping a movement of a barrier.

12. The method of claim 1 wherein the command includes information indicating an identity of a single barrier.

13. The method of claim 1 wherein a command includes information indicating identities of a multiple barriers.

14. The method of claim 1 comprising operating each of the plurality of barriers in a learn mode.

15. A barrier operator for actuating one or more barriers in a barrier operator system, the central barrier operator comprising:
a receiver for receiving a command;
a motor; and
a controller coupled to the receiver and the motor, the controller being programmed to determine whether the command received at the receiver is a valid command, and when the command is a valid command, to determine an identity of at least one barrier of a plurality of barriers based upon information included within the command, and, upon determination of the identity of the at least one barrier, the controller being programmed to responsively couple the motor to a coupling mechanism associated with the at least one barrier identified in the command.

16. The barrier operator of claim 15 wherein the at least one barrier comprises all of the plurality of barriers.

17. The barrier operator of claim 15 wherein at least one barrier comprises more than one of the plurality of barriers

18. The barrier operator of claim 15 wherein the at least one barrier comprises a single barrier of the plurality of barriers independently from the others.

19. The barrier operator of claim 15 wherein the controller is coupled to a sensor positioned at a selected one of the plurality of barriers, the controller being programmed to detect an obstruction at the selected one of the plurality of barriers based upon signals received from the sensor.

20. The barrier operator of claim 19 wherein the controller is programmed to transmit a signal to the selected one of the plurality of barriers to take an evasive action upon detection of an obstruction.

21. The barrier operator of claim 20 wherein the evasive action is selected from a group comprising: opening a barrier, closing a barrier, and stopping a movement of a barrier.

22. The barrier operator of claim 15 wherein the command comprises information indicating an identity of a single barrier.

23. The barrier operator of claim 15 wherein the command comprises information indicating identities of multiple barriers.

24. The barrier operator of claim 15 wherein the controller is programmed to operate each of the barriers in a learn mode.

25. The barrier operator of claim 15 wherein the at least one barrier comprises a first barrier and a second barrier and wherein the central barrier operator is positioned between the first barrier and the second barrier.

26. The barrier operator of claim 15 wherein the at least one barrier comprises a plurality of barriers positioned along a single structure and wherein the central barrier operator is positioned at the end of a shaft that is coupled to each of the plurality of barriers.

27. The barrier operator of claim 15 wherein the command comprises an RF signal transmitted by a portable transmitter.

28. The barrier operator of claim 15 wherein the command comprises an electrical signal from a keypad.

29. A system for controlling multiple barriers comprising:
a plurality of barriers;
a barrier actuation mechanism coupled to the plurality of barriers; and
a barrier operator power plant coupled to the barrier actuation mechanism, the barrier operator power plant receiving commands to selectively actuate selected ones of the plurality of barriers via the barrier actuation mechanism.

30. The system of claim 29 wherein the barrier actuation mechanism comprises a plurality of coupling mechanisms.

31. The system of claim 29 wherein the plurality of barriers comprises a first barrier and a second barrier and the barrier operator power plant is positioned between the first barrier and the second barrier.

32. The system of claim 29 wherein the plurality of barriers are positioned along a single structure and wherein the barrier operator power plant is positioned at the end of a shaft that is coupled to each of the plurality of barriers.

33. The system of claim 29 comprising at least one obstruction detection sensor at least one of the plurality of barriers.

34. The system of claim 33 wherein the barrier operator power plant receives information from the at least one sensor and determines whether an obstruction is present at the at least one barrier based upon the information.

35. The system of claim 34 wherein the barrier operator power plant is programmed to transmit a signal to the at least one barrier whenever it is determined that an obstruction is present.

36. The system of claim 35 wherein the evasive action is selected from a group comprising: opening a barrier, closing a barrier, and stopping a movement of a barrier.

37. The system of claim 29 wherein the plurality of barriers comprise a plurality of barriers selected from a group comprising: garage doors, sliding gates, swinging gates, and shutters.
